(19) United States
(12) Patent Application Publication
(10) Pub. No.: US 2007/0094242 A1
(43) Pub. Date: Apr. 26, 2007

(54) System and method for returning search results

(76) Inventors: John Dove, Arlington, MA (US); Albert Lee Stevens, Arlington, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/258,837

(22) Filed: Oct. 26, 2005

(51) Int. Cl. G06F 17/30

(52) U.S. Cl. 707/3

(57) ABSTRACT

The present invention provides a system and method for re-ordering the results from an information search, such as an Internet search in order to maximize the likelihood that the user will see a result they want in the first page or two of large or very large results lists. The results of the information search are examined for a wide variety of factors that could be considered to create diversity among the results a user is most likely to see. A subset of results are selected, with some results from each categorized group, for presentation to the user. The user is presented with a diverse set of search results so that the desired information may be located and/or the search narrowed more efficiently. This is easily extended to include any process which can benefit from receiving results from an information search where the receiving process benefits from having a high degree of variation occur among the first subset of results returned.

### BACKGROUND OF THE INVENTION

1. Field of the Invention

The present invention relates to searching systems. More particularly, it relates to a system for selecting and returning the results of a computer search.

2. Discussion of Related Art

Many systems exist for searching electronically stored information. The Internet has increased the number and nature of such searching systems, as well as dramatically increasing the amount of information to be searched. These systems use a variety of techniques to elicit the user's criteria for what types of records, documents, web-pages, books, sections, chapters, paragraphs, images, or other possible results will be of interest to them. Some of the common techniques include matching key words or phrases, looking for words that sound like the entered word, or misspellings of that word, Boolean combinations of words and phrases. Most online query systems support both a general search, as well as ‘advanced search’ options. Either or both may allow exclusions, and may reference descriptive information about the potentially interesting result in addition to content of the record itself (dates associated with the creation of the record, language it is written in, media and formats of the record, and other characteristics of the desired results). Other factors such as popularity of the use of or links to the terms or phrases mentioned in the query, paid for placement so that certain results will be guaranteed higher placement in the rank-order for certain queries, etc. also enter in to the ordering of sets of results.

All of these query systems end up with a set of results which is considered to be in ranked order of relevance from highest to lowest relevance to the user's query. The problems with relevance ranked returning of query results are several:

Even if a user uses all the advanced criteria specifications that a search system might provide (and many never use such a feature), this is only an approximation of what a user really wants. Further scrutiny by the user is necessary to find the exact information that the user wants.

A further problem is that for almost any inquiry other than checking the simplest fact, the user is unaware of the full range of possibilities of what could be returned and so cannot specify something that they are not even aware of as a possibility.

Finally, all these problems are made significantly worse by the fact that today the information bases searched by Internet search engines are incredibly large. Almost every user today experiences entering search terms and discovering that they get more than 100,000 or even more than 1,000,000 hits (results which satisfy the search criteria). They look at the first page or two of the results list but could never possibly examine the whole list.

Some systems attempt to deal with the fact that users do not or cannot specify what they really want (or may even misspell or mistype words in their query) by proposing alternative terms, for example “Did you mean . . . ?” But this technique, while sometimes helping a user restate their query, does not address the problems listed above.

Library Science has developed many techniques for dealing with optimizing the chances that a user comes away from the library with just the information that they would be most satisfied with. Cataloging systems and classification systems like the Dewey Decimal System (and many others) attempt to place books and resources in similar locations in order to make it easier to find resources that are related to one's area of interest. Cross-referencing in library catalogs and training librarians to conduct what is called the “reference interview” are all techniques which have been used to maximize the likelihood that users of libraries find what they are looking for. From the 1930s and on, libraries which allowed their users to browse through the libraries bookshelves themselves (called “open access” or “open stacks”) was seen as a method to add chance and serendipity to the user's search for useful material, finding things that they would not have known to ask for if relying only on the catalog and formal search systems. But none of these techniques really address the problems mentioned above, particularly those that involve the user evaluating results which are far too large to be effectively evaluated.

The problem with this approach is that many applications of query systems would benefit from having the results returned, not in rank order by relevance, but rather in an order that increases the variance of the first group of results returned so that the full breadth of variation in the whole returned set can be examined early in the process of evaluating or further processing of the results.

### SUMMARY OF THE INVENTION

The present invention works with the results of a search and changes the order in which they are returned for further processing. In a particular embodiment of the invention as it applies to presenting results of an online information search to a user on a computer screen, provides a unique process for returning the results which are chosen to be displayed in the first page or two of results. Instead of presenting the returned results in strict order of ranking, the present invention selects from the results list a set of results which are chosen on the basis of being divergent one from the others so far picked for presentation. These results, of course, coming from the search's list of results all meet the requirements that the user has specified. The invention, however, purposely places in the first page or pages entries that are different from each other. In this way the user receives first answers to the query which are different, one from the other and therefore much more likely to include the full breadth of possible answers to the query.

In its full generality this invention is useful whenever a search system returns results for further processing where the receiving process is improved by getting the results in an order that maximizes the variation of the results in an early portion of the returned results.

### BRIEF DESCRIPTION OF THE DRAWINGS

FIG. 1 illustrates a searching system and related information storage in connection with an embodiment of the present invention.

FIG. 2 is a block flow diagram of a result organization system according to an embodiment of the present invention.

### DETAILED DESCRIPTION

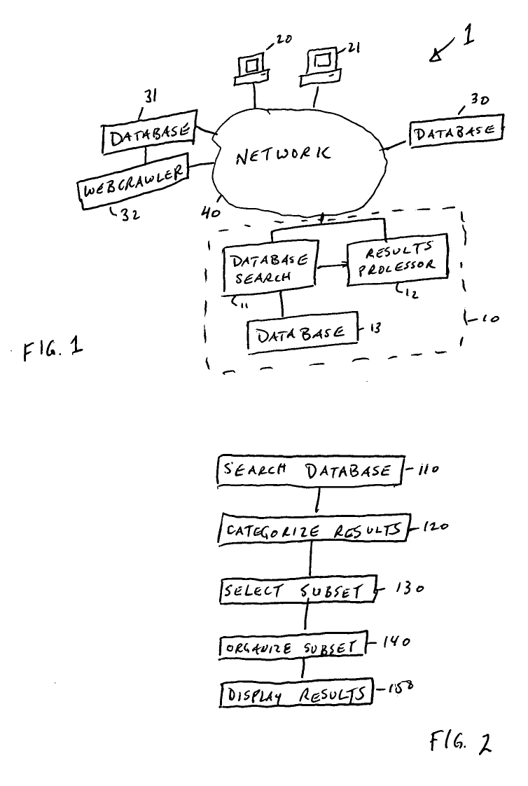

The present invention relates to any type of searching system and any type of stored information to be searched. Representative hardware for an information storage and searching system 1 is illustrated in FIG. 1. The information storage and searching system 1 includes a searching subsystem 10 for searching information and returning the results. As illustrated in FIG. 1, information to be searched is stored in one or more databases 13, 30, 31. For purposes of the present invention, a database is merely a structure for storing searchable information. It may include the information itself, or data relating to information stored elsewhere. According to an embodiment of the invention, the searching subsystem 10 includes a database 13, a database search 11 and a results processor 12. The searching subsystem 10 may be implemented with an appropriately programmed general purpose computer or a special purpose computer. The database 13 is stored in a memory of the computer. The database search 11 operates as an application stored in the memory and executed on a processor of the computer. The database search 11 may include any known process for searching the database. The results of the search are provided to the results processor 12. The results processor 12 is also an application stored in the memory and executed on that processor of the computer. The results processor 12 operates in the manner described below to order the results and present them to a user or other computer process. According to an embodiment of the invention, the searching subsystem 10 operates as a stand alone device operating on a single computer. In such an embodiment, the searching subsystem 10 includes input and output devices, not shown, such as a keyboard, mouse, and display. The input and output devices are used to input the keywords or other search terms to the database search 11 and to return the results to the user.

According to an embodiment of the invention, the searching subsystem 10 is connected to a network 40 for allowing remote operation of the searching subsystem. A client computer 20, 21 connected to the network 40 may operate the searching subsystem 10. The network 40 may be of any type including, but not limited to, a local area network, wide area network, world wide network such as the Internet, a private network, and a public network. For network operation, the database search 11 and results processor 12 include appropriate programming for communication with a client across a network. The client 20, 21 may include a browser for communication with the network 40 and display of information from the network 40.

Additionally, in a networked embodiment, the searching subsystem 10 may be used to search databases 30, 31 residing in other devices on the network 40. Additionally, the databases may be created in any manner. For example, a webcrawler 32 can be used to collect information about websites to be included in as database 31 which can be searched with the searching subsystem 10. Additionally, although the results processor 12 and database search 11 are illustrated in a single computer, they may be located on different devices. The database search 11 need only provide the results of a search to the results processor 12. Furthermore, the database search 11 and results processor 12 may be formed as a single application.

In accordance with the present invention, the results of a search are re-ordered to provide the user with a diverse set of results as an initial set. Existing searching systems typically order the search results according to how closely they match the search terms. Thus, the earliest results provided to the user tend to be related. While this type of return can be useful if the user knows exactly what he or she is looking for and how to describe it well for the search, it does not help those who are less clear on their objectives. A diverse set of results allows a user to locate desired information with less precise searching criteria. It may also allow the user to narrow the search more efficiently by providing information from which the user can determine keywords relating to his desired information. For example, a novice user may lack knowledge of the proper vocabulary used in the area which he or she is searching. Additionally, the user may not be able to precisely distinguish the desired information. Under current Internet searching systems, a user has no way to easily distinguish searches seeking information about a type of product from searches seeking to purchase the product. Providing a diverse set of results allows the user to more quickly locate the type of information desired.

A process for re-ordering the search results is illustrated in FIG. 2. At step 10, the database 13 is searched. In the searching subsystem 10 described above, step 10 is performed by the database search 11. The results of the search are provided to the results processor 12 to perform the remaining steps of the process of FIG. 2. At step 120, the results returned by the database search are categorized to determine variation. Variation of the returned results can depend upon the nature of the information in the database. The objective is to increase the variation in the first portion of the results which are returned to answer the query. The variation may depend upon the type of information in each entry, source of the information, types of attached files to the information, dates and other metadata which describes the information such as length and existence or not of various data structures. For example, a search of the world wide web may separate results into websites, news reports, articles, product information, sales information, etc. Alternatively, or in addition, the results processor may separate information by the format of the information. For example, a search may separate text, hypertext, PDF files, pictures, audio, and video.

A subset of the search results is selected at step 130 to be provided to the user first. The size of the subset may include one or more pages of results to be presented to the user. The subset is selected to provide diverse results among the first portions of the results returned. The subset may also include multiple results for each of the diverse types. The process for determining that one result is divergent from previously examined results can use any known method. At steps 140 and 150, the subset of results are organized and returned to the user.

According to an embodiment of the invention, the system need not categorize all of the search results at step 120 nor completely separate the categorization 120 and subset selection 130 steps. An objective of the invention is to initially provide the user with a set of diverse results from the search. The ranked results may be reviewed and the first one (or few) of each diverse type in the ranked results can be selected for initial presentation to the user. Thus, each result is analyzed to determine its variation, but the determined variations are not maintained. The selected results form the subset for presentation to the user. After a user reviews the diverse subset of results, the remaining search results may be presented to the user. They can be presented in the ranked order, or could be further processed to continually provide the user with diverse sets of results.

A simple example illustrates an embodiment of the invention. A user is reading a paper which mentions the acronym ATM. He can tell from context that it is not Automatic Teller Machine. He does a query on an information resource hoping to find what this particular acronym means in this context. In the interest of time or from habit he simply uses ATM as the query term. His query system will determine through a variety of mechanisms which results are most relevant to him, which are most popular among people querying on the term ATM, or which companies may have paid money to have ATM highly placed in results lists of queries mentioning ATM. These results will include many related to Automatic Teller Machines, which the user knows is not his desired result. Furthermore, it is likely that these results will dominate among those presented in the relevance ranked results. The categorization and subset selection steps of the present invention ensure that the results initially provided to the user include a variety of results. Thus, it is more likely that the user will find results with different uses of the acronym ATM, so that the unknown meaning can be found.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A method for presenting results of a search of stored electronic information comprising the steps of:
categorizing at least a portion of the results;
selecting a subset of the results, wherein the subset includes a diverse group of categorized results; and
presenting the subset of results to the user.

2. The method for presenting results of a search of stored electronic information according to claim 1, wherein the categorizing step includes the step of locating a set of diverse results.

3. The method for presenting results of a search of stored electronic information according to claim 1, wherein the search includes a search of the World Wide Web.

4. The method for presenting results of a search of stored electronic information according to claim 1, wherein the search includes the search of a database.

5. A system for searching stored electronic information and returning results to a user comprising:
a search subsystem for conducing a search of the stored electronic information according to a criteria identified by the user and returning a set of results;
a results processing subsystem for organizing the results for presentation such that a diverse set of results are first returned to the user.

6. The system for searching stored electronic information and returning results to a user according to claim 5, wherein the results processing subsystem includes:
a categorizer for categorizing at least a portion of the results;
a selector for selecting a subset of the results, wherein the subset of the results includes a diverse group of the categorized results; and
a display for displaying the subset of results.
